(19) United States
(12) Patent Application Publication
(10) Pub. No.: US 2018/0376489 A1
(43) Pub. Date: Dec. 27, 2018

(54) INTEGRATED SCHEDULER FOR SCHEDULING WITH X-HAUL CAPACITY CONSTRAINTS

(71) Applicant: Nokia Solutions and Networks OY, Espoo (FI)

(72) Inventors: Matthew ANDREWS, Chatham, NJ (US); Prasanth ANANTH, Bridgewater, NJ (US); Abhishek SINHA, Murray Hill, NJ (US)

(73) Assignee: Nokia Solutions and Networks OY, Espoo (FI)

(21) Appl. No.: 15/630,367

(22) Filed: Jun. 22, 2017

(51) Int. Cl. H04W 72/12

(52) U.S. Cl. CPC H04W 72/1252

(57) ABSTRACT

Some example embodiments are directed to an apparatus for performing integrated scheduling in a cloud-based virtualized radio access network (vRAN) architecture including one or more central units (CUs) configured to communicate with one or more remote units (RUs) over an x-haul transport network. The apparatus is configured to determine time-varying channel constraints based on a condition of an access link between the one or more RUs and one or more user equipment (UEs), the access link being in one of a wireless or wireline network, determine x-haul capacity constraints based on an amount of capacity available on an x-haul link between the one or more CUs and the one or more RUs, the x-haul link being in the x-haul transport network, and jointly schedule transmissions to the one or more UEs based on the time-varying channel constraints and the x-haul capacity constraints.

### BACKGROUND

There are two trends that will have a large effect on the structure of 5G wireless access. The first is the trend towards denser small cells with deeper fiber, which is sometimes described using the slogan “long wires and short wireless.” The second is the trend towards virtualized Radio Access Network (vRAN) architectures in which part of the processing and network intelligence (including scheduling) takes place in central units (CUs) located in a cloud data center (sometimes called an edge cloud) and then the data is carried over a transport network called x-haul to a set of remote units (RUs).

A passive optical network (PON) is ideally suited for such x-haul due to its high capacity, lower cost, and ability to reuse existing fiber-to-the-x (FTTx) distribution networks. However, in cases utilizing such an architecture, there is a need to ensure that the scheduling in the central units respects the PON capacity in addition to the air interface capacity.

There are many variants of vRAN architecture that differ based on how the processing is split between the CUs and the RUs. At a high-level, these options can be categorized into two types: a fronthaul architecture and a midhaul architecture. In a fronthaul architecture, all of the processing right down to the baseband takes place in the edge cloud. By contrast, in a midhaul architecture, some of the higher-layer processing takes place in the edge cloud while the lower physical layer processing takes place at the RUs. In this case, the midhaul capacity requirement will change depending on the actual amount of user traffic. A midhaul architecture can be more advantageous compared to fronthaul, since it requires lesser bandwidth on the x-haul transport network.

In many cases, the PON may not be carrying traffic solely to wireless RUs. In a converged architecture, it might also be connecting CUs and RUs that correspond to DSL or Cable access, as well as traditional FTTx services. In this case, a slice of the total capacity is typically reserved just for the wireless remote nodes.

Desirably, the central units should schedule the wireless transmissions so that the PON capacity constraints are satisfied in addition to the air interface constraints. From a logical standpoint, it would not make sense for the centralized scheduling decision to only worry about the air interface resources if the data to be scheduled overloads the PON midhaul. In order to minimize latency, it is desirable to perform the scheduling in such a way that there is no queue build-up at the RUs.

However, these respective constraints are of opposing nature. For the air interface, the fundamental resource unit is the resource block (RB), which may convert into bit rate in different ways according to the channel conditions. On the other hand, for the PON the fundamental resource unit is bit rate itself. For example, considering only the air interface constraints, the scheduler may wish to serve a user that is in a good channel condition. However, considering only the PON constraints, the scheduler may prefer to not schedule that user if the PON cannot handle the resulting data.

### SUMMARY

Some example embodiments are directed to an apparatus for performing integrated scheduling in a cloud-based virtualized radio access network (vRAN) architecture including one or more central units (CUs) and one or more remote units (RUs), the one or more CUs being configured to communicate with the one or more RUs over an x-haul transport network, the apparatus including a memory storing computer-readable instructions and at least one processor associated with the one or more CUs configured to execute the computer-readable instructions to determine time-varying channel constraints based on a condition of an access link between the one or more RUs and one or more user equipment (UEs), the access link being in one of a wireless or wireline network, determine x-haul capacity constraints based on an amount of capacity available on an x-haul link between the one or more CUs and the one or more RUs, the x-haul link being in the x-haul transport network, and jointly schedule transmissions to the one or more UEs based on the time-varying channel constraints and the x-haul capacity constraints.

In some example embodiments, the at least one processor is configured to execute the computer-readable instructions to jointly schedule transmissions to the one or more UEs by determining values which maximize an objective function subject to the time-varying channel constraints and the x-haul capacity constraints.

In some example embodiments, the jointly scheduling transmissions to the one or more UEs based on maximizing the objective function includes, for each time step, scheduling the UE that maximizes a defined criterion for each RU and resource block (RB) pair with respect to the time-varying channel constraints and the x-haul capacity constraints, tracking an amount of capacity being used and an amount of capacity remaining available on the x-haul link, and repeating the scheduling and the tracking until the amount of capacity available on the x-haul link is exhausted.

In some example embodiments, the jointly scheduling transmissions to the one or more UEs includes avoiding scheduling a UE that would violate the x-haul capacity constraints in response to the amount of capacity available on the x-haul link being unable to handle an amount of traffic associated with the UE.

In some example embodiments, the jointly scheduling transmissions to the one or more UEs includes scaling down an allocated rate for a UE in proportion to the condition of the access link of the UE based on the amount of capacity available on the x-haul link such that the x-haul capacity constraints are satisfied.

In some example embodiments, the determining the values which maximize the objective function subject to the time-varying channel constraints and the x-haul capacity constraints is performed according to a linear programming (LP) fractional relaxation, wherein an RB can be shared among multiple UEs in a solution to the LP fractional relaxation.

In some example embodiments, the at least one processor is further configured to execute the computer-readable instructions to iteratively apply an LP solving algorithm to solve the LP fractional relaxation, and solving the LP fractional relaxation gives the solution to the LP fractional relaxation in terms of fractional variables.

In some example embodiments, the iteratively applying the LP solving algorithm to solve the LP fractional relaxation is followed by a rounding procedure of the solution to the LP fractional relaxation, at most one RB per RU can be shared among multiple UEs and all other RBs per RU are allocated to at most one UE, and the at most one RB per RU is allocated to one UE that contributes most to maximizing the objective function out of the multiple UEs, such that the at least one processor is configured to execute the computer-readable instructions to schedule the one UE of the multiple UEs for each RU and RB pair based on the rounding procedure.

In some example embodiments, the iteratively applying the LP solving algorithm to solve the LP fractional relaxation is followed by randomized rounding of the solution to the LP fractional relaxation, the randomized rounding treats the solution to the LP fractional relaxation in terms of fractional variables as probabilities, such that the at least one processor is configured to execute the computer-readable instructions to schedule one UE of the multiple UEs for each RU and RB pair based on the randomized rounding according to the probabilities.

In some example embodiments, the determining the values which maximize the objective function subject to the time-varying channel constraints and the x-haul capacity constraints is performed according to a dynamic programming (DP) recursion, the DP recursion including iteratively calculating optimal solutions for a subset of RBs and a subset of total x-haul capacity, and building a lookup table for all possible values in order to determine the values which maximize the objective function subject to the time-varying channel constraints and the x-haul capacity constraints.

In some example embodiments, the x-haul transport network includes a passive optical network (PON).

In some example embodiments, the x-haul transport network is shared between the x-haul link and at least one other communication link, and only a slice of total capacity of the x-haul transport network is reserved for the x-haul link.

In some example embodiments, there is a total bound (C) on the amount of capacity available on the x-haul link.

In some example embodiments, there are separate bounds (Cᵢ) on the amount of capacity available on the x-haul link for each individual RU of the one or more RUs.

In some example embodiments, the access link is associated with a wireless air interface between the one or more RUs and the one or more UEs.

Some example embodiments are directed to a method for performing integrated scheduling in a cloud-based virtualized radio access network (vRAN) architecture including one or more central units (CUs) and one or more remote units (RUs), the one or more CUs being configured to communicate with the one or more RUs over an x-haul transport network, the method including determining time-varying channel constraints based on a condition of an access link between the one or more RUs and one or more user equipment (UEs), the access link being in one of a wireless or wireline network, determining x-haul capacity constraints based on an amount of capacity available on an x-haul link between the one or more CUs and the one or more RUs, the x-haul link being in the x-haul transport network, and jointly scheduling transmissions to the one or more UEs based on the time-varying channel constraints and the x-haul capacity constraints.

### BRIEF DESCRIPTION OF THE DRAWINGS

Example embodiments will be more clearly understood from the following detailed description taken in conjunction with the accompanying drawings, wherein like elements are represented by like reference numerals, which are given by way of illustration only and thus are not limiting of example embodiments. FIGS. 1-4 represent non-limiting, example embodiments as described herein.

FIG. 1 illustrates the system components that form a Virtualized Radio Access Network (vRAN), including an x-haul transport network, according to an example embodiment.

FIGS. 2A and 2B illustrate respective hardware components of a central unit (CU) and a remote unit (RU), respectively, according to some example embodiments.

FIG. 3 illustrates various baseband processing layers, where some of the baseband processing functions may be split between a central unit (CU) and a remote unit (RU) at various split points (i.e., the baseband processing layers) in the x-haul transport network, according to some example embodiments.

FIG. 4 illustrates a flowchart describing the joint scheduling functionality associated with a CU, according to an example embodiment.

### DETAILED DESCRIPTION

Various example embodiments will now be described more fully with reference to the accompanying drawings in which some example embodiments are illustrated.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

Example embodiments are discussed herein as being implemented in a suitable computing environment. Although not required, example embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular abstract data types.

In the following description, illustrative embodiments will be described with reference to acts and symbolic representations of operations (e.g., in the form of flowcharts, flow diagrams, data flow diagrams, structure diagrams, block diagrams, etc.) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers, system-on-chip (SoC) or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of example embodiments are typically encoded on some form of tangible (or recording) storage medium. The tangible storage medium may be magnetic (e.g., a floppy disk or a hard drive), optical (e.g., a compact disk read only memory, or “CD ROM”), and may be read-only memory (ROM), random access memory (RAM), flash memory (e.g., USB flash drives, memory cards, memory sticks, etc.), for example. The terms “tangible storage medium” and “memory” may be used interchangeably. Example embodiments are not limited by these aspects of any given implementation.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

According to example embodiments, schedulers, hosts, cloud-based servers, etc., may be (or include) hardware, firmware, hardware executing software or any combination thereof. Such hardware may include one or more Central Processing Units (CPUs), system-on-chip (SOC) devices, digital signal processors (DSPs), application-specific-integrated-circuits (ASICs), field programmable gate arrays (FPGAs) computers or the like configured as special purpose machines to perform the functions described herein as well as any other well-known functions of these elements. In at least some cases, CPUs, SOCs, DSPs, ASICs and FPGAs may generally be referred to as processing circuits, processors and/or microprocessors.

The schedulers, hosts, servers, etc., may also include various interfaces including one or more transmitters/receivers connected to one or more antennas, a computer readable medium, and (optionally) a display device. The one or more interfaces may be configured to transmit/receive (wireline and/or wirelessly) data or control signals via respective data and control planes or interfaces to/from one or more switches, gateways, MMEs, controllers, eNBs, servers, client devices, etc.

Virtualized Radio Access Network (vRAN) Architecture

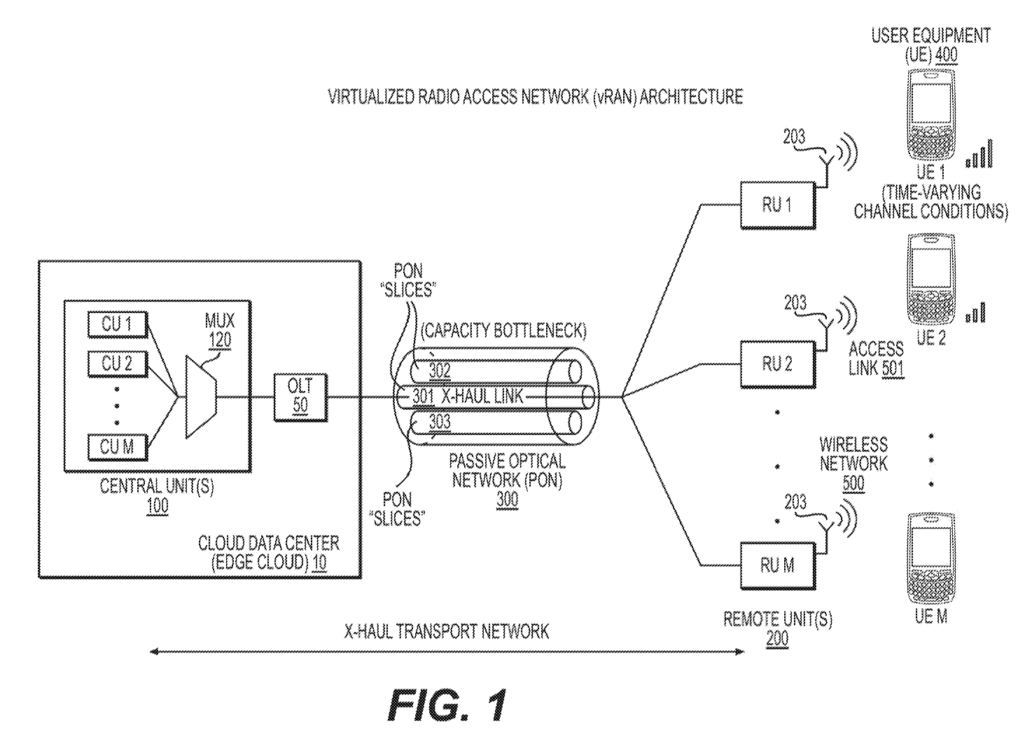

FIG. 1 illustrates the system components that form a Virtualized Radio Access Network (vRAN), including an x-haul transport network, according to an example embodiment.

As shown in FIG. 1, the vRAN architecture includes one or more central units (CUs) 100 located in a cloud data center 10 (also known as an edge cloud) and one or more remote units (RUs) 200 located in the field.

In a vRAN architecture, certain base station functionalities are virtualized using cloud computing technologies. The RUs are low-cost remote radio units that are centrally managed by one or more centralized units, or CUs, in the cloud. Some of the baseband and higher-layer processing operations of base stations may be implemented on centralized, general-purpose computing hardware of the CUs, rather than on the local hardware of the wireless access nodes, or RUs. On the other hand, the RUs may implement lower-layer processing operations, including wireless access point radio functionalities, and may not implement the entire protocol stack of conventional base stations in some example embodiments.

In some example embodiments, the CUs 100 are configured to communicate with the RUs 200 via an x-haul transport network, which may include a passive optical network (PON) 300 in some example embodiments. In some example embodiments, the PON 300 may include a plurality of PON “slices,” wherein one of the PON slices may correspond to x-haul link 301. The other PON slices (e.g., 302, 303) may be associated with a variety of different links (e.g., other use cases). In some example embodiments, PON 300 may have limited capacity (e.g., bandwidth), wherein only a portion of the limited capacity may be reserved for the x-haul link 301. In this manner, the PON 300 may be considered a “capacity bottleneck,” due to the x-haul link sharing the bandwidth of PON 300 with other links.

In some example embodiments, there may be a single CU 100. A CU 100 may be connected to an optical line terminal (OLT) 50, which is configured to provide an interface to the x-haul transport network (e.g., PON 300). In some example embodiments, a CU 100 may include a plurality of central units (e.g., CU 1, CU 2, . . . , CU M), wherein communications associated with the plurality of CUs may be combined via a multiplexer (MUX) 120, which may be connected to the OLT 50.

In some example embodiments, there may be a plurality of RUs 200 (e.g., RU 1, RU 2, . . . , RU M). In some example embodiments, the RUs 200 are configured to communicate wirelessly with one or more user equipment (UEs) 400 (e.g., UE 1, UE 2, . . . , UE M) via a wireless network 500 (e.g., a wireless local area network (WLAN), a wide-area network (WAN), etc.). In this regard, each RU may include a network interface 203 (e.g., an antenna) for establishing wireless access links 501 with UEs 400.

However, it should be noted that a PON and a WLAN or WAN are merely non-limiting examples of the types of networks of a vRAN architecture, and other similar types of network technologies are also contemplated.

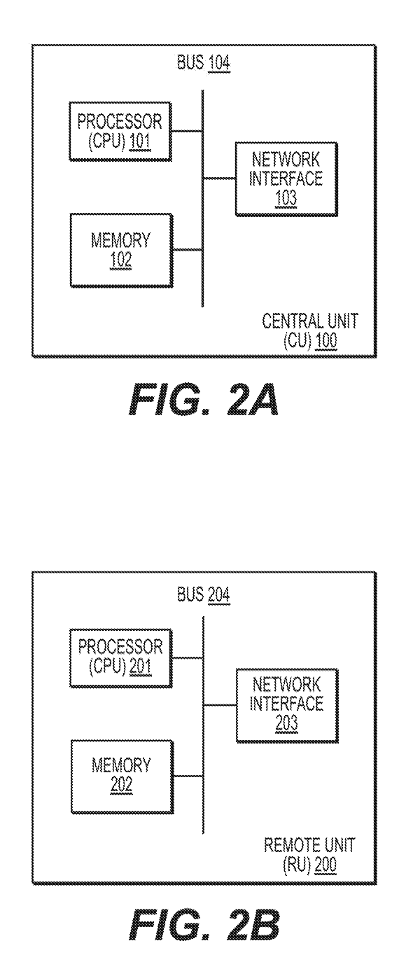

FIGS. 2A and 2B illustrate respective hardware components of a central unit (CU) 100 and a remote unit (RU) 200, respectively, according to some example embodiments.

As shown in FIG. 2A, a CU 100 includes a processor (CPU) 101, a memory 102, a network interface 103, and a bus 104. As shown in FIG. 2B, an RU 200 includes a processor (CPU) 201, a memory 202, a network interface 203, and a bus 204.

The processors 101 and 201 included in CU 100 and RU 200, respectively, may be, but not limited to, a Central Processing Unit (CPU), a controller, an arithmetic logic unit (ALU), a digital signal processor, a microcomputer, a field programmable gate array (FPGA), an Application Specific Integrated Circuit (ASIC), a System-on-Chip (SoC), a programmable logic unit, a microprocessor, or any other device capable of performing operations in a defined manner.

The memory 102 and 202 included in CU 100 and RU 200, respectively, may be a computer readable storage medium that generally includes a random access memory (RAM), read only memory (ROM), and/or a permanent mass storage device, such as a disk drive or solid state drive. The memory 102 and 202 also stores an operating system and any other routines/modules/applications for providing the functionalities of the CU 100 and RU 200, respectively. These software components may also be loaded from a separate computer readable storage medium into the memory 102 and 202 using a drive mechanism (not shown). Such separate computer readable storage medium may include a disc, tape, DVD/CD-ROM drive, memory card, or other like computer readable storage medium (not shown). In some example embodiments, software components may be loaded into the memory 102 and 202 via one or more interfaces (not shown), rather than via a computer readable storage medium.

The network interfaces 103 and 203 included in CU 100 and RU 200, respectively, may include various interfaces including one or more transmitters/receivers (or transceivers) connected to one or more antennas or wires to wirelessly or wiredly transmit/receive control and data signals. The transmitters may be devices that include hardware and software for transmitting signals including, for example, control signals or data signals via one or more wired and/or wireless connections to other network elements over a network. Likewise, the receivers may be devices that include hardware and software for receiving signals including, for example, control signals or data signals via one or more wired and/or wireless connections to other network elements over the network.

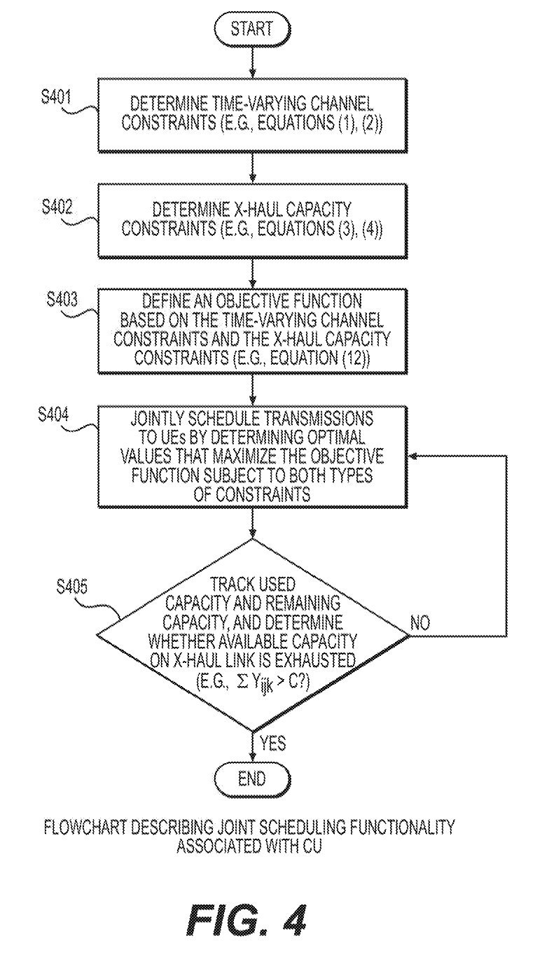

In some example embodiments, the CPU 101 of a CU 100 may be configured to execute computer-readable instructions stored in the memory 102 of CU 100 in order to perform the method for scheduling transmission considering x-haul transport network capacity constraints in addition to the time-varying channel conditions of the wireless access network, according to an example embodiment such as described with respect to FIG. 4. In some example embodiments, the integrated scheduling functionality may be implemented by a combination of hardware components and software programs, which may be located in a single CU 100 or distributed across multiple CUs 100 in cloud data center 10.

In some example embodiments, RUs include the network interface hardware and software for communicating with CUs. Depending on where the processing split point between the CUs and RUs occurs, with respect to functionalities at Layer 1 (PHY) and below and Layer 2 (MAC) and above, fewer or additional hardware components and software programs may be required at the RUs in order to coordinate and communicate with the CUs.

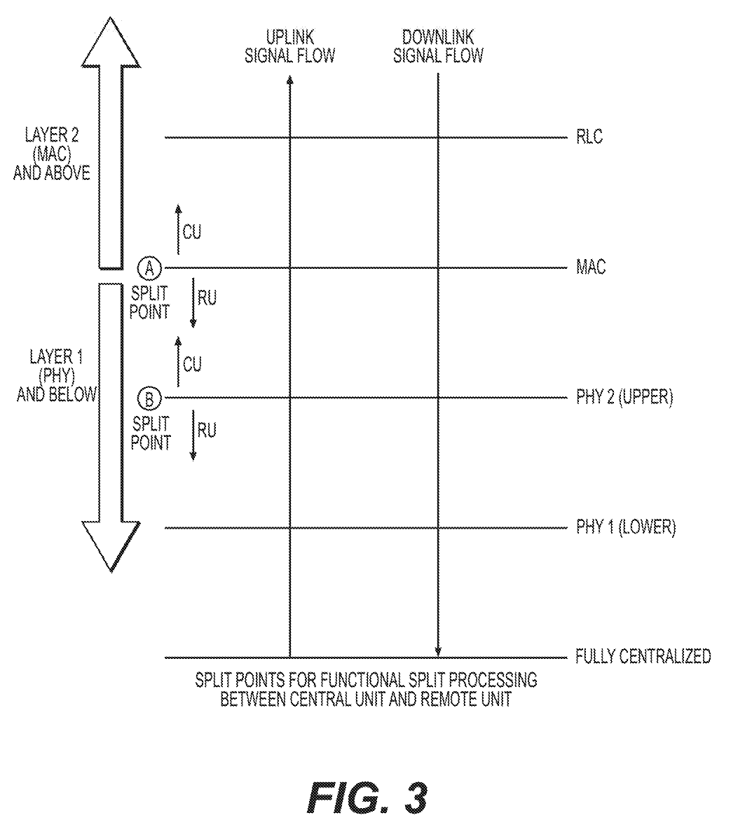

FIG. 3 illustrates various baseband processing layers, where some of the baseband processing functions may be split between a central unit (CU) 100 and a remote unit (RU) 200 at various split points (i.e., of the baseband protocol stack) in the x-haul transport network, according to some example embodiments. In conventional RAN base stations, all of the baseband processing functions, including lower physical layer (PHY1), upper physical layer (PHY2), medium access control (MAC), radio link control (RLC), and higher processing layers are performed by the base stations. In a fully centralized RAN, all of these baseband processing functions are performed by the CUs. In a partially centralized RAN, some of the lower baseband processing functions may be performed by the RUs while some of the upper baseband processing functions may be performed by the CUs.

As shown in FIG. 3, in some example embodiments, the baseband protocol stack processing split between the CUs and RUs may occur between medium access control (MAC) and upper physical layer (PHY2). This is illustrated as “split point A” in FIG. 3. However, the disclosed techniques are not limited to this option, and the processing split may instead occur at various other points, such as between the upper physical layer (PHY2) and lower physical layer (PHY1), etc. in some other example embodiments. This is illustrated as “split point B” in FIG. 3. The solutions for performing integrated scheduling disclosed herein are designed to apply regardless of where the processing split happens.

### Theory

Some mathematical background including various example algorithms that may be utilized for achieving the joint scheduling functionality disclosed herein will be described below.

I. Background: Split Processing

Current standards such as the Common Public Radio Interface (CPRI) prescribe a split point where all the baseband processing functions are in the CU and the sampled digital baseband signal is then transported to the corresponding RU (in the field) where it is converted to analog signals to transmit/receive over the air. The transport network for this split is commonly referred to as fronthaul. Fronthaul requires low latency (<250 μs one-way) along with very high and constant data rates (several Gbps). It is commonly believed that fronthaul is not a sustainable approach as the state of the art proceeds to 5G.

Consequently, several alternate split points have been suggested to reduce the data rate requirements and, in some cases, also the latency requirement. These alternate options are broadly referred to as midhaul. As discussed above, FIG. 3 shows various examples of these split points.

For split points above PHY2, the transport data rates depend on the actual user rate. In contrast, for fronthaul (i.e., fully centralized), the transport data rates are constant (i.e., independent of the actual user rate) and in the order of several Gbps. Thus, the higher split points provide more than an order of magnitude reduction in the data rate required for the transport network.

The term “x-haul” is used herein to refer to the superset of all the split options covering fronthaul and midhaul. Although there are several split options, a commonality for many is that the scheduler (e.g., in Layer 2) is centralized.

II. Problem Formulation

This section provides a formal definition of the optimization problem sought to be addressed by example embodiments, using existing theory of gradient ascent over time-varying channels to convert the long-run objective into a local objective for a single timeslot.

Assume that i is used to index RUs, j is used to index end-users, and [symbol] is used to index RBs. Let γᵢⱼₖ(t) represent the channel conditions for user j associated with RU i on RB [symbol] at time t (i.e., at the tth transmission time interval, or TTI). Let xᵢⱼₖ(t) be a binary variable that represents whether or not RB [symbol] at RU i is assigned to user j at time t. Let yᵢⱼₖ(t) be the rate that is assigned to user j at RU i at time t. The xᵢⱼₖ(t) and the yᵢⱼₖ(t) are the decision variables. Thus, the optimization problem formulation has the following constraints at time t

γᵢⱼₖ(t)≤γᵢⱼₖ(t)xᵢⱼₖ(t) (1)

Σⱼxᵢⱼₖ≤1 ∀i,k (2)

Σⱼₖγᵢⱼₖ(t)≤Cᵢ∀i (3)

Σᵢⱼₖγᵢⱼₖ(t)≤C (4)

xᵢⱼₖ∈{0,1} (5)

The above equations define a more general problem which considers a capacity constraint G applicable to each RU i in constraint (3), in addition to the total capacity constraint C accounted in (4). Both the general multiple constraint problem above, as well as a specific single capacity constraint case where only constraint (4) applies, are analyzed herein.

Strictly speaking, the data rate that results over the midhaul link is a function, denoted by J), of the rate yᵢⱼₖ that is assigned to the user. So, the constraints (3) and (4) above should in fact be:

Σⱼₖƒ(γᵢⱼₖ(t))≤Cᵢ∀i (6)

Σᵢⱼₖƒ(γᵢⱼₖ(t))≤C. (7)

If ƒ(·) is a linear function, then it can be transformed back into the form in (3) and (4) as follows:

Σⱼₖγᵢⱼₖ(t)≤ƒ⁻¹(Cᵢ)∀i (8)

Σᵢⱼₖγᵢⱼₖ(t)≤ƒ⁻¹(C), (9)

where ƒ⁻¹(·) is the inverse of ƒ(·). Even if the actual function is not linear, a linear upper bound can be used and the above applies. Therefore, the form in (3) and (4) will be used herein for easier understanding.

In order to specify the objective, a long-term service rate is defined for user j at RU i that evolves according to:

Rᵢⱼ(t+1)=(1−ε)Rᵢⱼ(t)+εΣₖγᵢⱼₖ(t). (10)

The goal is to maximize Σᵢⱼ U(Rᵢⱼ(t)) for some concave function U(·), e.g., U(x)=log x. The correct way to perform this optimization is by finding the yᵢⱼₖ(t) and the xᵢⱼₖ(t) at each time-step that maximize:

ΣᵢⱼU(Rᵢⱼ(t))Σₖγᵢⱼₖ(t), (11)

subject to the constraints (1)-(4). This optimization problem is referred to as SINGLE-SHOT, where its optimal value is denoted as X*(t). For the common case in which U(x)=log x, the objective becomes:

$${Σ}_{ij} \frac{{Σ}_{k} {y}_{ijk} ( t )}{{R}_{ij} ( t )} . \qquad ( 12 )$$

For concreteness, this objective (12) is used in some example embodiments, but in general all of the results also apply to more general concave utility functions.

In the above optimization problem formulation, RUs and RBs are indexed differently, because they correspond to different physical entities. However, from a mathematical perspective, the focus only needs to be on the resources that need to be assigned, which in this case are the RU-RB pairs. Hence, some embodiments consider the case of a single RU in order to simplify the indexing. With appropriate choices for the γ₄(t) values, this simplification can always be made.

III. State-of-the-Art: Proportional Fair Algorithm

This section provides an illustrative example to show why standard greedy algorithms (e.g., the traditional Proportional Fair wireless scheduling algorithm) will not provide an optimal solution. The fundamental difficulty is that existing approaches cannot handle the mismatch between the wireless constraint and the PON constraint. It is also proven that the corresponding single-slot problem is NP-hard.

The well-known Proportional Fair (PF) algorithm is a standard wireless scheduling algorithm that assigns each RB [symbol] at RU i to the user j that maximizes γᵢⱼₖ(t)/Rᵢⱼ(t). However, the PF algorithm does so without considering the notion of any capacity constraints for the transport network (e.g., the PON capacity).

A counter-example shown below proves that the PF algorithm is not optimal, due to the constraints (3)-(4). This implies that the performance of the PF algorithm can be an arbitrarily large factor worse than the optimal performance.

Lemma 1:

Proportional Fair is not optimal in general, i.e., there exists values of γᵢⱼₖ(t), Rᵢⱼ(t), G, and C such that for the yᵢⱼₖ(t) produced by Proportional Fair, the following is obtained,

$${Σ}_{ij} \frac{{Σ}_{k} {y}_{ijk} ( t )}{{R}_{ij} ( t )} < {X}^{*} ( t ) .$$

Proof:

Consider an example that has 1 RU with 2 users and 4 resource blocks (RBs) (note that a very similar example with 4 RUs and 1 RB could be created). In this example, C=7 (a separate Q value is not needed, since there is only 1 RU in this example). The R values for the two users are given by,

R₀₀(t)=1

R₀₁(t)=2.

The instantaneous channel rates are given by,

γ₀₀ₖ(t)=1 ∀k

γ₀₁ₖ(t)=4∀k.

Since γ₀₁ₖ(t)/R₀₁(t)=2>1=γ₀₀ₖ(t)/R₀₀(t), Proportional Fair will pick user 1 for every RB, i.e., x₀₁ₖ(t)=1 and x₀₀ₖ(t)=0 for all [symbol] . In order to meet the capacity constraint, the y values are chosen such that Σₖ y₀₁ₖ(t)=7 and Σₖy₀₀ₖ(t)=0. Hence, the total objective is 7/2 in this example.

However, a better solution would put user 0 on 3 RBs and user 1 on a single RB. In this case, x₀₀ₖ(t)=1 and y₀₀ₖ(t)=1 for [symbol] <3, and x₀₁₃(t)=1 and y₀₁₃(t)=4. The total objective for this solution is 5.

IV. Preliminaries

This section presents a number of preliminaries, including three natural heuristics that may be used as a baseline, a structural result on the optimal solution, and two linear programming relaxations of the original problem.

a. Heuristic Algorithms

Three algorithms may be derived from heuristics. For these algorithms, a particular theoretical performance cannot mathematically be guaranteed. Their performance may be compared using simulations.

Algorithm MAX-YIELD: This is the simplest adaptation of the traditional PF algorithm such that it respects the capacity constraints. The algorithm works by going through the RUs and RBs one-by-one and always picking the user that maximizes yᵢⱼₖ/Rᵢⱼ. At each step, the used and remaining capacity on the PON is tracked and the algorithm stops when the available capacity is exhausted. (A natural way to order the RUs and RBs for this process is in decreasing order of maxⱼ yᵢⱼₖ/Rᵢⱼ).

Algorithm MAX-VALUE:

This algorithm works by going through the RUs and RBs one-by-one and always picking the user that maximizes 1/Rᵢⱼ. At each step, the used and remaining capacity on the PON is tracked and the algorithm stops when the available capacity is exhausted. (Once again, a natural way to order the RUs and RBs for this process is in decreasing order of maxⱼ

Algorithm SCALED-PF:

This algorithm is another adaptation of the traditional PF algorithm such that it respects the capacity constraints. The algorithm works by running PF first, going through the RUs and RBs one-by-one and always picking the user that maximizes yᵢⱼₖ/Rᵢⱼ (without worrying about the capacity constraints). Considering the problem with a single capacity constraint (C), if this constraint is not violated then the allocated rate yᵢⱼₖ=γᵢⱼₖ for the users selected by PF in the previous step. On the other hand, if this constraint is violated then the allocated rate yᵢⱼₖ for the selected users is scaled down in proportion to their γᵢⱼₖ such that the capacity constraint is satisfied, i.e., yᵢⱼₖ=yᵢⱼₖ(C/T), where T is the sum of γᵢⱼₖ for all selected users. For the problem with multiple capacity constraints (Cᵢ), the allocated rates can be similarly scaled down in two steps, once for the capacity constraints C per RU, and once for the total capacity constraint C. (Note that these two steps could be performed in either order).

Whereas MAX-YIELD tries to optimize the objective with respect to the wireless resources, MAX-VALUE tries to optimize the objective with respect to the PON capacity constraints.

b. Structural Results

In some sense, the difficulty of the optimization problem comes from the fact that the optimal solution may split service between users with high values of 1/R and users with high values of γ/R. Recall from Lemma 1 that if the PF algorithm violates the capacities C and C then it can be suboptimal. An easy result may be stated that if this violation does not happen, then PF (which becomes equivalent to MAX-YIELD) is in fact optimal.

Lemma 2:

Support that under algorithm PF we can set yᵢⱼ [symbol] (t)=γᵢⱼ(t) xᵢⱼ [symbol] (t) without violating the capacities C and Cᵢ. Then, algorithm PF achieves X*(t).

Proof:

Follows from the fact that the “most” objective that may be obtained from resource block [symbol] is maxⱼ γᵢⱼ [symbol] (t)/Rᵢⱼ(t). If algorithm PF achieves that without running into the capacity constraint, then it is optimal.

Next, a structural theorem is presented that allows a determination of the optimal y values for any solution specified by the x values.

Lemma 3:

Suppose that a set of x values are given that satisfy the constraint Σⱼxᵢⱼ [symbol] (t)≤1 for all i, [symbol] . The optimal y values may be found for this set of x values via the following procedure:

First, order the ij [symbol] triples in decreasing order of 1/Rᵢⱼ(t). Then, go through each in turn. When considering triple ij [symbol] set,

yᵢⱼ [symbol] (t)←max{γᵢⱼ [symbol] (t)xᵢⱼ [symbol] (t),C−Σ_{i′j′} [symbol] _{′}y_{i′j′} [symbol] _{′}Cᵢ−Σ_{j′} [symbol] _{′}y_{ij′} [symbol] _{′}}.

In other words, set yᵢⱼ [symbol] (t) as large as possible without violating any of the constraints.

Proof:

Let y* represent the optimal solution. Consider the ij [symbol] triples in the order above and consider the first for which yᵢⱼ [symbol] (t) according to the above algorithm is different from y*ᵢⱼ [symbol] (t). Since the yᵢⱼ [symbol] (t) values have been made as large as possible subject to all of the constraints, it must be the case that y*ᵢⱼ [symbol] (t)<yᵢⱼ [symbol] (t). Now, increase in a continuous manner until y*ᵢⱼ [symbol] (t)=yᵢⱼ [symbol] (t). In order to do this, some other y* values may need to be decreased. It is not necessary to do this for i′j′ [symbol] ′ triples that have already been considered since yᵢⱼ [symbol] (t) does not violate any constraints. If there is a value y*_{i′j′k′}(t)>0 for a later triple ij′ [symbol] ′ at the same RU, then that value is decreased until either it hits zero or all the constraints are satisfied. If there is no such y*_{ij′k′}(t) at the same RU, then do the same but for a later y*_{i′j′k′} value at a different RU. Such a value can always be found, since otherwise y*_{i′j′k′}(t)=0 for all later triples. This cannot be true if the y* values satisfy the constraints since the y values represent a feasible solution.

Since y*_{i′j′k′}(t) for a later triple is being decreased, it must be the case that 1/Rᵢⱼₖ(t)≥1/R_{i′j′k′}. Hence, the objective function for the y* values cannot get any worse as the changes are made. If this procedure is repeated continuously, then eventually the y*values will equal the y values. This implies that the y values found from the above procedure give an optimal solution.

Lemma 3 allows a function ƒ(x) to be defined that equals the optimal value of the objective for any given vector x whose components consist of the zᵢⱼₖ(t) values.

c. LP Relaxation

There are two LP relaxations for the original optimization problem. These relaxations can be solved efficiently. The relaxation is given by,

$$max {\sum }_{ij} \frac{{Σ}_{k} {y}_{ijk} ( t )}{{R}_{ij} ( t )}$$

$$s . t . \\ {y}_{ijk} ( t ) \leq {γ}_{ijk} ( t ) {x}_{ijk} ( t )$$

$${\sum }_{j} {x}_{ijk} \leq 1 ∀ i , k$$

$${\sum }_{jk} {y}_{ijk} ( t ) \leq {C}_{i} ∀ i$$

$${\sum }_{ijk} {y}_{ijk} ( t ) \leq C$$

$${x}_{ijk} ∈ [ 0 , 1 ] .$$

The only difference from the true optimization problem is that the binary constraint xᵢⱼₖ∈{0,1} has been replaced by the continuous constraint Σₖ∈[0,1], i.e., a RB can now be split across multiple users.

This LP can be solved with arbitrary precision by the following iterative algorithm, which is based on an algorithm for packing and covering problems. (The dependence on t is dropped, for ease of notation). This iterative algorithm is governed by a parameter e and maintains variables Xᵢⱼₖ, uᵢₖ, vᵢ, w. Initially, Xᵢⱼₖ=0 and uᵢₖ=1, vᵢ, 1/Cᵢ and w=1/C for all ij [symbol] Each iteration works as follows (repeating for as many iterations as are feasible in the time available):

$$( 1 ) Let {i}^{′} {j}^{′} {k}^{′} = arg {min}_{ijk} \{ {R}_{ij} ( {u}_{ik} + {γ}_{ijk} {v}_{i} + {γ}_{ijk} w ) \} , \\ ( 2 ) increase {X}_{{i}^{′} {j}^{′} {k}^{′}} by 1 , \\ ( 3 ) set {u}_{{i}^{′} {k}^{′}} ← {u}_{{i}^{′} {k}^{′}} ( 1 + ɛ ) , {v}_{{i}^{′}} ← {v}_{{i}^{′}} ( 1 + {ɛγ}_{{i}^{′} {j}^{′} {k}^{′}} \text{/} {C}_{{i}^{′}} ) , w ← w ( 1 + {ɛγ}_{{i}^{′} {j}^{′} {k}^{′}} \text{/} C ) , and$$

$$( 4 ) let$$

$$α = max \{ {max}_{ik} {\sum }_{j} {X}_{ijk} , {max}_{i} {\sum }_{jk} {γ}_{ijk} {X}_{ijk} \text{/} {C}_{i} , {\sum }_{ijk} {γ}_{ijk} {X}_{ijk} \text{/} C \} . \\ Set {x}_{ijk} = {X}_{ijk} \text{/} α for all ijk .$$

In the sequel the following equivalent LP may be used, in which the yᵢⱼₖ variables are removed so as to focus solely on the fractional yᵢⱼₖ's. In particular, the equality constraint yᵢⱼₖ=xᵢⱼₖγᵢⱼₖ can be forced, letting the xᵢⱼₖ's be a real number in [0, 1]. By substituting yᵢⱼₖ←xᵢⱼₖγᵢⱼₖ, an LP is obtained in terms of the continuous variables x only as shown below:

$$max {\sum }_{ijk} {x}_{ijk} \frac{{γ}_{ijk}}{{R}_{ij}}$$

$$Subject to , \\ {\sum }_{j} {x}_{ijk} \leq 1 , ∀ k$$

$$and , \\ {Σ}_{ijk} {γ}_{ijk} {x}_{ijk} \leq C , \\ {Σ}_{jk} {γ}_{ijk} {x}_{ijk} \leq {C}_{i} , x \geq 0.$$

V. Algorithms with a Single Capacity Constraint

This section presents algorithms for the special case in which there is only a single capacity bound C. In particular, a ½-approximation algorithm is given that is based on rounding a linear program (LP) and which relies on a special structure of the basic feasible solutions for that LP. Two exact Dynamic Programming (DP) solutions that run in pseudo-polynomial time are also provided. For one of the dynamic programs, the solutions are converted to a Fully Polynomial-Time Approximation Scheme (FPTAS).

Begin with a special case in which there is a single bound on the PON capacity, denoted as C. (This special case does not have the separate base station capacities C). Considering the problem of optimal resource allocation when there is only a single base station (BS) is acceptable due to the equivalence of RUs and RBs, as described above in Section II. As a consequence, the BS index i will be dropped in the following development. Start with the following definition:

Definition 1:

A feasible rate allocation vector y is called DISCRETE if yⱼₖ=xⱼₖγⱼₖ, ∀k.

In other words, in a DISCRETE allocation either the RB is allocated maximum wireless rate limited by the wireless interface rate or it is not allocated any rate at all. Starting with a structural result which shows that for all but (at most) one RB, the optimal allocation has yⱼₖ={0, yⱼₖ}.

Definition 2:

A feasible rate allocation vector is called ALMOST DISCRETE if yⱼₖ=xⱼₖγⱼₖ for all RB k but (at most) one.

Next, a useful structural theorem is proven.

Theorem 4:

There exists an optimal solution of (12) which is ALMOST DISCRETE.

Proof:

Follows directly from Lemma 3 since that lemma implies that once the xⱼₖ values are set, the optimal yⱼₖ values can be found by simply going through each of them in order of 1/Rⱼ. Each one is filled up to an amount γⱼₖ before moving on to the next one.

Next, it will be shown that an optimal solution to DISCRETE automatically leads to an approximate solution to ALMOST DISCRETE.

Theorem 5:

Any optimal solution for DISCRETE automatically leads to a ½-approximation to ALMOST DISCRETE.

Proof:

From Theorem 4, it is known that there is an optimal solution to (12) that is ALMOST DISCRETE. In such a solution, an RB k is considered “utilized” if y*ⱼₖ=γⱼₖ and “under-utilized” if 0<yⱼₖ<yⱼₖ for some j with x*ⱼₖ=1. Then,

OPT=Utilized RBs+Under-Utilized RB≤2max{Utilized RBs,Under-Utilized RB}

Hence,

max{Utilized RBs,Under-Utilized RB}≥½OPT (13)

Now, consider the strategy π of optimizing each of the terms in the left-hand-side of Equation (13) separately, and taking the maximum of them. To maximize the second term, take the maximum over the various RBs and allocate it to the full extent, i.e.,

$${k}^{*} = arg {max}_{jk} \frac{1}{{R}_{j}} min \{ {γ}_{jk} , C \} . \qquad ( 14 )$$

If there is an optimal solution for DISCRETE, then this directly implies a maximization for the first term.

a. Algorithm ROUNDING-AD

In view of Theorem 4, an LP based algorithm ROUNDING-AD will now be considered, where AD stands for Almost Discrete, for approximately solving the optimization problem. The second LP relaxation presented in Section IV-c above is used (but with the indexing over i removed).

$$\begin{matrix}max {\sum }_{jk} {x}_{jk} \frac{{γ}_{jk}}{{R}_{j}} \\ Subject to , \\ {\sum }_{j} {x}_{jk} \leq 1 , ∀ k \\ and & ( 15 ) \\ {\sum }_{jk} {γ}_{jk} {x}_{jk} \leq C , x \geq 0 & ( 16 )\end{matrix}$$

The above linear program is called LP₂.

Theorem 6:

An optimal solution of LP₂ has at most two fractional-variables.

Proof.

Introducing the non-negative auxiliary variables ζₖ, ∀k in (15) and ξ in (16), the following set of equality constraints is obtained:

Σⱼxⱼₖ+ζₖ=1,∀k

Σⱼₖγⱼₖxⱼₖ+ξ=C (17)

where x, ξ, ξ≥0. The optimal solutions for LPs are obtained by Basic Feasible Solutions (BFS). Since there are (K+1) equality constraints in (17), at most (K+1) variables could be strictly positive in any BFS. Also, from the first constraint in (17), it follows that there is at least one strictly positive variable per equality constraint. This implies (by the pigeon hole principle) that in the optimal solution of the above LP, there exists (at most) one RB which has been allocated to two users. Moreover, all other RBs have been allocated to (at most) one user only.

Step 2: Rounding Leading to a ½-Approximation Algorithm:

The above fractional solution may be easily converted to a feasible ½ approximate solution of the original problem. Let the value of the optimal solution returned by the above LP and the original mixed integer linear program (MILP) be denoted by OPT′ and OPT, respectively. Any feasible solution of the original MILP may be used to construct a feasible solution of the above LP with the same objective value. Hence,

OPT′≥OPT.

Also denote the objective value returned by the integral and the fractional portions of OPT′ be I, F₁, and F₂, respectively. Now, choosing the maximum of F₁ and F₂ and augmenting it with the integral portion of the solution I, clearly there is a feasible solution of the original problem and,

I+max{F₁,F₂}≥½(I+F₁+F₂)=½OPT′≥½OPT.

In summary, algorithm ROUNDING-AD works as follows:
(1) solve linear program LP₂ using the iterative approach outlined above in Section IV-c, and
(2) if an RB is shared among two users, give it to the user that contributes the most to the objective (i.e., schedule the “best user” at the given timeslot).

If the optimal solution returned by the LP contains at most one fractional variable xⱼₖ, then there is no need for rounding and it gives the optimal solution of the original problem.

b. NP-Hardness of Discrete

The well-known NP-hard problem Subset Sum may be reduced to Discrete.

In the Subset Sum problem, a set of positive integers S={γ₁, γ₂, . . . , γₖ} and a target number C are given. The problem is to decide whether there exists a subset A⊂S such that sum of elements of the set A is exactly C.

To reduce Subset Sum to Discrete, consider a single user problem in which there are [symbol] RBs with their γ values given by the set S and the PON capacity to be C. Also assume R₁=1. Then, if and only if the Discrete problem returns the optimal profit to be C, then there exists a solution to the Subset Sum problem.

c. Pseudo Polynomial-Time Algorithm (DP-I)

It is also possible to devise a pseudo polynomial-time algorithm based on Dynamic Programming (DP) for the problem, when a mild restriction is imposed that the allocated rates must be integers. (Note that this is not a restriction at all when all inputs are integrals under a standard assumption, which follows from Lemma 3). Thus, the constraint reduces to,

yᵢⱼ [symbol] ={0,1,2, . . . ,γᵢⱼ [symbol] }xᵢⱼ

[symbol]

Assume that the RBs are added sequentially in the order RB 1, RB 2, . . . , RB K. The optimal value of the program is denoted by V(R, [symbol] ) when using total PON capacity of R and adding first [symbol] RBs. Then, the following DP recursion is obtained,

$$V ( M , k ) = {max}_{j} {max}_{{y}_{jk}} ( \frac{1}{{R}_{j}} {y}_{jk} + V ( M - {y}_{jk} , k - 1 ) ) , \qquad ( 18 )$$

where in the above maximization,

γⱼ [symbol] ∈{0,1,2, . . . ,min(M,γⱼ [symbol] )},∀j.

The algorithm works as follows:
(1) for all M, [symbol] , compute V(M, [symbol] ) using the recursion (18), and
(2) if y maximizes the value of (18), then the solution with PON capacity M and [symbol] k RBs is given by allocating yⱼ [symbol] units of bandwidth to user j on RB [symbol] and then augmenting it with the solution for V(M−yⱼ [symbol] , [symbol] −1) on the remaining RBs.

d. Pseudo Polynomial-Time Algorithm (DP-II)

A different DP for DISCRETE can be obtained, which is dual to the above DP in some sense.

The (ordered) set of RBs under consideration for the RSS problem is denoted by S, |S|=K. The maximum profit obtained by using a single RB is

$${p}_{max} = {max}_{j , k} \frac{1}{{R}_{j}} {γ}_{jk} .$$

For each integer p, 0≤p≤Kpₘₐₓ, define C( [symbol] , p) to be the minimum amount of PON capacity needed to obtain a profit of p by using only the first [symbol] RBs of the set S. Naturally, C( [symbol] , p) is defined to be +∞ if the profit p cannot be obtained by using the first [symbol] RBs in the set S. Then, the following DP recursion on C(·,·) is obtained,

$$C ( k , p ) = {min}_{j} ( C ( k - 1 , p - \frac{1}{{R}_{j}} {γ}_{jk} ) + {γ}_{jk} ) .$$

In the above recursion, the minimization is over all j's such that

$$p \leq \frac{1}{{R}_{j}} {γ}_{jk} .$$

Since a PON capacity budget of C is provided, the optimal solution to RSS is obtained by:

max(p:C(K,p)≤C), (19)

which can be obtained by a simple binary search on the last row of C(K,·). Hence, the algorithm works as follows:
(1) For all [symbol] , p, compute C( [symbol] , p) using the recursion (19),
(2) if j minimizes the value of (19), then the solution for [symbol] RBs and profit p is given by allocating γⱼ [symbol] units of bandwidth to user j on RB [symbol] , and then augmenting it with the solution for

$$C ( k - 1 , p - \frac{1}{{R}_{j}} {γ}_{jk} ) + {γ}_{jk}$$

on the remaining RBs, and
(3) use binary search on the profit values to find max{p: C(K,p)≤C}.

e. An FPTAS for Discrete

The above DP (DP-II) has running time O(KC), which is pseudo-polynomial in the input size. However, using appropriate scaling techniques similar to the Knapsack problem, it is possible to obtain FPTAS for Discrete. Such scaling may involve rounding the y values such that they are all multiples of some given integer (e.g., multiples of 10). (However, with this rounding there is a tradeoff between the eventual accuracy of the algorithm and the running time).

Total profit for any RB (irrespective of the PON capacity) is upper-bounded by pₘₐₓ=max_{j,} [symbol] Qⱼγⱼ [symbol] . Fix an ϵ>0 and define a scaling factor

$$W = \frac{ϵ {p}_{max}}{K - 1} .$$

The profit obtained when the RB [symbol] is assigned to the user j is denoted by pⱼₖ. Thus, pⱼ [symbol] =Qⱼγⱼ [symbol] .

Now, consider the RSS problem for which

$${p}_{jk}^{′} = ⌊ \frac{{p}_{jk}}{w} ⌋ , ∀ j , k .$$

When solved by the DP algorithm, this reduced problem has a table size of

$$O ( K \times \frac{K}{ϵ} )$$

and the minimization step at each cell requires O(N) computation. Thus, the overall scheme has run-time complexity of

$$O ( \frac{{K}^{2} N}{ϵ} ) .$$

Next, bound the profit obtained by the reduced problem (after scaling p′ⱼ [symbol] s up by a factor of W) in terms of the profit of the optimal solution.

f. Approximation Factor

The approximate scaling algorithm is denoted by A′ and the optimal algorithm is denoted by OPT. Since A′ is optimal for p′ⱼₖ, by definition the following is obtained,

$${\sum }_{jk} {p}_{jk}^{′} ( {A}^{′} ) \geq {\sum }_{jk} {p}_{jk}^{′} ( OPT )$$

$$\text{Hence,}$$

$$\begin{matrix}Profit ( {A}^{′} ) = W {\sum }_{jk} {p}_{jk}^{′} ( {A}^{′} ) \geq W {\sum }_{jk} {p}_{jk}^{′} ( OPT ) \geq \\ W {\sum }_{jk} ( \frac{{p}_{jk}}{W} - 1 ) ( OPT ) \\ = Profit ( OPT ) - W ( K - 1 ) \\ = Profit ( OPT ) - ϵ {p}_{max} \geq ( 1 - ϵ ) Profit ( OPT ) ,\end{matrix}$$

where the last inequality follows because Profit(OPT)≥pₘₐₓ. This is achievable because the input has been filtered to allow only those γⱼₖs such that C≥maxⱼγⱼₖ.

g. ½−ϵ Approximation FPTAS for ALMOST DISCRETE

Combining the FPTAS for DISCRETE with the strategy gi from Theorem 5, a ½−ϵ FPTAS for ALMOST DISCRETE may readily be obtained.

VI. Algorithms for the General Problem

This section presents algorithms for the general problem, including a matroid-based approach that achieves a solution that is always within a ½-factor of optimal.

There are two approximation algorithms for the general problem in which there is a bound on the general PON capacity denoted as C, as well as bounds on the individual RU capacities denoted as Cᵢ. The first is a greedy algorithm called MATROID that is based on the theory of optimizing a submodular function over a matroid. The second algorithm called ROUNDING is based on rounding the solution to a fractional relaxation of the problem.

a. Algorithm MATROID

First, the Greedy algorithm MATROID is described, for which the objective is always within a factor 2 of optimal. Suppose there is a set of xᵢⱼₖ(t) values such that Σⱼxᵢⱼₖ≤1 for all ik. Implicitly, these values define a partition matroid since there is at most one user per RB at each RU. Moreover, the optimal associated yᵢⱼₖ(t) values can be calculated via Lemma 3. For a vector x=(xᵢⱼₖ(t)), let ƒ(x) be the associated objective. It is trivial to show that ƒ(·) is a submodular function. The Greedy algorithm works by initializing all xᵢⱼₖ(t) to 0, and then repeatedly choosing an xᵢⱼₖ(t) value that maintains the constraint Σⱼxᵢⱼₖ(t)≤1, and which maximizes the increase in ƒ(x). In particular for any vector x, let n(x) be the number of xᵢⱼₖ(t) variables in x that are set to 1. The algorithm works as follows: (1) initialize x to the zero vector, and (2) repeat: find a vector i that maximizes ƒ(x̅−x) subject to n(x̅)−n(x)=1. Such an i can be found by considering each possible xᵢⱼₖ(t) for augmenting x.

Lemma 7:

The yᵢⱼₖ(t) values produced by Greedy satisfy,

$${\sum }_{ij} \frac{{\sum }_{k} {y}_{ijk} ( t )}{{R}_{ij} ( t )} \geq {X}^{*} ( t ) / 2.$$

Proof:

This is a direct result of an algorithm for maximizing a submodular function over a matroid.

b. Algorithm ROUNDING

Algorithm ROUNDING is based on the following fractional relaxation of the SINGLE-SHOT problem, which is then followed by randomized rounding.

$$max {\sum }_{ij} \frac{{\sum }_{k} {y}_{ijk} ( t )}{{R}_{ij} ( t )}$$

$$s . t . \\ {y}_{ijk} ( t ) \leq {γ}_{ijk} ( t ) {x}_{ijk} ( t )$$

$${\sum }_{j} {x}_{ijk} \leq 1 \qquad ∀ i , k$$

$${\sum }_{jk} {y}_{ijk} ( t ) \leq {C}_{i} \qquad ∀ i$$

$${\sum }_{ijk} {y}_{ijk} ( t ) \leq C$$

$${x}_{ijk} ∈ [ 0 \text{,} 1 ] .$$

The only difference from the true optimization problem is that the binary constraint xᵢⱼₖ∈(0,1) has been replaced by the continuous constraint xᵢⱼₖ∈[0,1], i.e., a RB can now be split across multiple users. This relaxation is a linear program (LP) that can theoretically be solved efficiently (although it might still be infeasible to do on a time-slot by time-slot basis). Let \hat{x}ᵢⱼₖ(t) and ŷᵢⱼₖ(t) represent the optimal solution to the linear program. Next, it is shown how this is converted into a solution that satisfies the constraints of the SINGLE-SHOT problem.

The principle of randomized rounding is rather simple. For each RU i and RB k, pick among the users j with a probability proportional to \vec{x}ᵢⱼₖ(t). (These values can be treated as probabilities, since Σⱼ \hat{x}ᵢⱼₖ≤1). If xᵢⱼₖ(t)=0, then yᵢⱼₖ(t)=0. If xᵢⱼₖ(t)=1, then set yᵢⱼₖ(t)=\hat{x}ᵢⱼₖ(t)/\hat{x}ᵢⱼₖ(t).

By linearity of expectation, the expected objective value of the rounded solution is no worse than the expected objective value of the fractional solution. It remains to determine whether the capacity constraints are satisfied. For this purpose, a Hoeffding bound is utilized. In particular, let N by the number of users at RU i, let=Σᵢ Nᵢ, and let K be the number of RBs in the system. Then, the following is obtained by a standard Hoeffding bound,

$$Pr [ {\sum }_{jk} {y}_{ijk} ( t ) \geq {C}_{i} + d ] \leq exp ( - 2 {d}^{2} / {\sum }_{jk} {γ}_{ijk}^{2} ) and$$

$$Pr [ {\sum }_{ijk} {y}_{ijk} ( t ) \geq C + d ] \leq exp ( - 2 {d}^{2} / {\sum }_{ijk} {γ}_{ijk}^{2} )$$

If B is the number of RUs, then set d=\sqrt{(log B) Σᵢⱼₖγᵢⱼₖ²}.

c. Fast Solution to the LP

Next, a simple iterative algorithm for solving the LP will be described. (The dependence on t is dropped, for ease of notation). The algorithm has a parameter ε and maintains the variables Xᵢⱼₖ, uᵢₖ, vᵢ, w. Initially, Xᵢⱼₖ=0 and uᵢₖ=1, vᵢ=1/Cᵢ and w=1/C for all ijk. Each iteration works as follows (repeating for as many iterations as are feasible):

$$( 1 ) Let {i}^{′} {j}^{′} {k}^{′} = arg {min}_{ijk} \{ {R}_{ij} ( {u}_{ik} + {γ}_{ijk} {v}_{i} + {γ}_{ijk} w ) \} , \\ ( 2 ) increase {X}_{{i}^{′} {j}^{′} {k}^{′}} by 1 , \\ ( 3 ) set {u}_{{i}^{′} {k}^{′}} ← {u}_{{i}^{′} {k}^{′}} ( 1 + ɛ ) , \\ {v}_{{i}^{′}} ← {v}_{{i}^{′}} ( 1 + {ɛγ}_{{i}^{′} {j}^{′} {k}^{′}} / {C}_{{i}^{′}} ) , w ← w ( 1 + {ɛγ}_{{i}^{′} {j}^{′} {k}^{′}} / C ) , and \\ ( 4 ) let$$

$$α = max \{ {max}_{ik} {\sum }_{j} {X}_{ijk} , {max}_{i} {\sum }_{jk} {γ}_{ijk} {X}_{ijk} / {C}_{i} , {\sum }_{ijk} {γ}_{ijk} {X}_{ijk} / C \} . \\ Set {x}_{ijk} = {X}_{ijk} / α for all ijk .$$

d. Remark on ROUNDING Algorithm: Integrality Gap

The optimal solution to the relaxed problem might lead to a higher value of the optimization objective compared to the original problem.

Lemma 8:

The optimal solution to the relaxation of the SINGLE-SHOT problem might be fractional. Hence, there is an integrality gap for the relaxation.

Proof:

This example is very similar to the above example that showed the sub-optimality of basic Proportional Fair. In particular, it has 1 RU with 2 users and 4 RBs. The R values for the two users are given by,

R₀₀(t)=1

R₀₁(t)=2.

The instantaneous channel rates are given by,

γ₀₀ₖ(t)=1 ∀k

γ₀ₖ(t)=4 ∀k.

Consider the solution for a generic value of C. In particular, let N=Σₖx₁₀₁ₖ(t), i.e., N is the number of RBs for which the schedule gives service to user 1. Desirably, N should be as large as possible while respecting the capacity constraint. Hence, in the fractional solution, set N=max{4, ⅓(C−4)}, which is non-integral for any C≤16 that is not a multiple of 4. The value of the solution is 2N+(4−N)=N+4. Hence, if N has to be rounded down to an integer, then clearly a suboptimal solution is obtained.

### Methodology

In an example embodiment, one or more CUs each communicate traffic with corresponding RUs over a common x-haul network (e.g., passive optical network, or PON) with a given limited capacity. This scenario occurs, for example, when the network used for x-haul is shared with other use cases (e.g., fiber-to-the-x, or FTTx, distribution networks) and only a “slice” of the total bandwidth is reserved for the x-haul transport. In theory, the x-haul bandwidth could be unlimited. However, for practical implementations of an x-haul transport network, some example embodiments address the problem where the x-haul capacity is limited. In some example embodiments, effective capacity on the x-haul link may vary based at least in part on where in the baseband protocol stack the functional processing split occurs between the CUs and RUs. In one particular class of split processing options, called midhaul, traffic over the x-haul link may depend at least in part on the actual user rate.

The term “scheduling” refers to allocating or assigning of cloud resources (e.g., RU-RB pairs) to UEs over time. Traditional scheduling algorithms take into account only the time-varying channel conditions of the access link (e.g., an air interface in the case of wireless) with the users. However, the existing scheduling algorithms do not account for x-haul capacity constraints (e.g., the amount of capacity available on the x-haul link).

Some example embodiments address the optimization problem of how the CUs should schedule the transmissions such that the x-haul capacity constraints are satisfied in addition to the access channel constraints. In some example embodiments, the transmission scheduling optimization may be performed jointly across multiple RUs.

In some example embodiments, the traditional Proportional Fair (PF) algorithm is adapted such that it respects the x-haul capacity constraints as well as the access channel constraints. One adaptation of the PF algorithm is referred to as “Max-Yield” herein. With the Max-Yield adaptation, the algorithm goes through the RUs and resource blocks (RBs) one-by-one and each time, assigns the RB to the user that maximizes the traditional PF defined criterion (i.e., yᵢⱼₖ/Rᵢⱼ). At each step, the used and remaining capacity on the x-haul transport network (PON) is tracked, and the algorithm stops when the available capacity is exhausted. Thus, the Max-Yield algorithm tries to optimize the objective with respect to the wireless resources. However, the Max-Yield adaptation may not always lead to optimal performance.

Another example adaptation of the PF algorithm, referred to as “Max-Value” herein, works by going through the RUs and RBs one-by-one and picking the UE that maximizes another defined criterion (i.e., 1/R). Again, at each step the used and remaining capacity on the x-haul transport network (PON) is tracked, and the algorithm stops when the available capacity is exhausted. Thus, the Max-Value algorithm tries to optimize the objective with respect to the PON capacity constraints.

The further adaptations of the algorithm described above can perform close to optimal, and can achieve over 2× better performance compared to conventional wireless scheduling algorithms in some example scenarios.

FIG. 4 illustrates a flowchart describing the joint scheduling functionality associated with a CU 100, according to some example embodiments.

According to some example embodiments, the CPU 101 of CU 100 may be configured to execute computer-readable instructions stored in the memory 102 of CU 100 in order to perform operations S401 through S405 of the method for scheduling transmission considering x-haul transport network capacity constraints in addition to the time-varying channel conditions of the wireless access network. In some example embodiments, CU 100 can mathematically formulate the resource allocation problem as an optimization problem with a certain objective function subject to involving constraints in the problem domain, assuming weighted sum-rate (WSR) maximization as the optimization objective.

In an initial operation (not shown in FIG. 4), parameters for the joint scheduling method are defined (or alternatively, initialized) at the CU 100. In some example embodiments, yᵢⱼₖ(t) represents the channel conditions for user j associated with RU i on RB k at time t (e.g., at the tth transmission time interval, or TTI), xᵢⱼₖ(t) is a binary variable that represents whether or not RB k at RU i is assigned to user j at time t, and yᵢⱼₖ(t) represents the rate that is assigned to user j at RU i at time t. The xᵢⱼₖ(t) and the yᵢⱼₖ(t) are the decision variables.

In some example embodiments of the joint scheduling method, subsequent operations S401 through S405 may be performed as an iterative process. For each time-step, a UE is selected to be scheduled (e.g., assigning each RB at RU to the UE) that maximizes the objective function for each RU and RB pair with respect to both of the time-varying channel constraints and the x-haul capacity constraints. At each time-step, the amount of capacity being used and remaining available on the PON x-haul link is tracked. The constraint determining, scheduling, and capacity tracking operations may be repeated until the amount of capacity available on the PON x-haul link is exhausted.

In operation S401, time-varying channel constraints are determined by the CU 100 (e.g., estimated, calculated, received, etc.) according to any of various methodologies which are well-known in the art. In some example embodiments, the time-varying channel constraints γᵢⱼₖ(t) may be based on channel conditions of wireless access links for UE j associated with RU i on RB k at time t, for example, due to wireless fading. These channel conditions may be measured by the UEs and forwarded along to the CUs via the RUs, for example. The fundamental resource unit associated with the time-varying channel constraints includes a resource block (RB). An RB may convert into bit rate in various different ways according to the condition of the access link between the RU and the UE. For example, considering only the time-varying channel constraints in a scheduling decision, a UE having a good channel condition would be scheduled.

In operation S402, x-haul capacity constraints are determined by the CU 100. For example, the capacity on the PON transport network that is reserved for the x-haul link may be given (or alternatively, predetermined) and may be limited. In some example embodiments, there may be separate PON capacity constraints Q for each RU according to equation (3), and/or a total PON capacity constraint C according to equation (4). In some example embodiments, the x-haul capacity constraints may be based on an amount of capacity available on the PON x-haul link between a CU and an RU. The fundamental resource unit associated with the x-haul capacity constraints includes the bit rate itself (e.g., the rate that is assigned to user j at RU i at time t). For example, considering only the x-haul capacity constraints in a scheduling decision, a UE that is otherwise in a good channel condition would not be scheduled if the amount of capacity available on the x-haul link would be unable to handle the resulting data traffic.

In operation S403, referring back to the Theory section above in some example embodiments, an objective function for the joint scheduling method is defined according to equation (12) such that equations (1) through (4) are satisfied. Thus, the problem formulation has constraints (1)-(5) at time t and the goal is to find the optimal values of yᵢⱼₖ(t) and xᵢⱼₖ(t) at each time step that maximize the objective function (12) with respect to the constraints. In other words, CU 100 may perform the joint scheduling method so as to decide which UE to serve in a given time slot, and then decide the number of RBs to serve them, so as to maximize the objective subject to both of the time-varying channel constraints and the x-haul capacity constraints.

In operation S404, joint scheduling of transmission to end-user devices is iteratively performed by CU 100 in a manner that satisfies both of the time-varying channel constraints as well as the x-haul capacity constraints. In some example embodiments, the joint scheduling operations may be performed according to the objective function (e.g., including but not limited to equation (12) above), by determining an optimal value Xᵢⱼₖ(t) for the objective function considering both types of constraints. In some example embodiments, a natural way to order the RUs and RBs for this process is in decreasing order of maxⱼ γᵢⱼₖ(t)/Rᵢⱼ. For each RU and RB, the CU 100 selects the UE that maximizes a defined optimization criterion for each RU and RB pair (e.g., γᵢⱼₖ/Rᵢⱼ in some example embodiments, or 1/Rᵢⱼ in some other example embodiments, although the defined optimization criterion is not limited to these examples).

In operation S405, at each time step, the used capacity (e.g., yᵢⱼₖ, which represents the rate that is assigned to user j at RU i at time t) and the available capacity remaining (e.g., Q and/or C) may be tracked and updated by the CU 100. The CU 100 determines whether the available capacity is exhausted, based on the tracking and updating of the used and remaining capacity associated with the x-haul link. If there is still some available capacity remaining (e.g., the method follows the “No” branch in FIG. 4 in response to equations (3) and/or (4) being satisfied), the joint scheduling method returns to S404, and operations S404 and S405 are repeated. On the other hand, if all of the available capacity is used (e.g., the method follows the “Yes” branch in FIG. 4 in response to equations (3) and/or (4) being violated), the process is terminated.

In some example embodiments, jointly scheduling transmission to the one or more UEs includes scaling down an allocated rate for a UE in proportion to the condition of the access link of the UE based on the amount of capacity available on the x-haul link such that the x-haul capacity constraints are satisfied.

As mentioned in the Theory section, solving the true optimization problem may become more computationally difficult as the number of RUs and UEs increases. Therefore, in order to reduce the processing burden on the CU in performing the joint scheduling operations, one or more of the linear programming (LP) and the dynamic programming (DP) techniques discussed in the Theory section may be used to solve the optimization problem more efficiently.

In some example embodiments, the CU may be configured to execute the computer-readable instructions to determine the optimal values which maximize the objective function subject to the time-varying channel constraints and the x-haul capacity constraints according to an LP fractional relaxation of the true optimization problem. In the LP fractional relaxation, the binary constraint xᵢⱼₖ∈{0,1} (i.e., which may be considered an “assign all or none” approach) is replaced by the continuous constraint xᵢⱼₖ∈[0,1] (i.e., which may be fractional), such that an RB can now be shared among multiple UEs in an optimal solution to the LP fractional relaxation. To determine the optimal values according to the LP fractional relaxation, the CU may iteratively apply an LP solving algorithm to solve the LP fractional relaxation, which gives the optimal solution to the LP fractional relaxation in terms of fractional variables. Starting with the optimal solution to the LP fractional relaxation, further adaptations of the optimization problem may be made.

In one related example embodiment starting with the optimal solution to the LP fractional relaxation, iteratively applying the LP solving algorithm to solve the LP fractional relaxation is followed by the CU executing the computer-readable instructions to perform a rounding procedure of the optimal solution to the LP fractional relaxation. According to the rounding procedure, at most one RB per RU can be shared among multiple UEs and all other RBs per RU are allocated to at most one UE. The at most one RB per RU is allocated to one UE that contributes most to maximizing the objective function out of the multiple UEs. In this manner, the CU may be configured to schedule one UE of the multiple UEs for each RU and RB pair based on the rounding procedure.

In another related example embodiment starting with the optimal solution to the LP fractional relaxation, iteratively applying the LP solving algorithm to solve the LP fractional relaxation is followed by the CU executing the computer-readable instructions to perform randomized rounding of the optimal solution to the LP fractional relaxation. The randomized rounding treats the optimal solution to the LP fractional relaxation in terms of fractional variables as probabilities. In this manner, the CU may be configured to schedule one UE of the multiple UEs for each RU and RB pair based on the randomized rounding according to the probabilities.

In some other example embodiments, the CU may be configured to execute the computer-readable instructions to determine the optimal values which maximize the objective function subject to the time-varying channel constraints and the x-haul capacity constraints by utilizing a DP recursion approach. The DP recursion includes iteratively calculating optimal solutions for a subset of RBs and a subset of total x-haul capacity, and building a lookup table for all possible values. By referring to the lookup table, the CU may be configured to determine the optimal values which maximize the objective function subject to the time-varying channel constraints and the x-haul capacity constraints according to the DP recursion.

In this manner, according to the various algorithms and adaptations thereof discussed above, the scheduling of transmissions to UEs may be optimized by considering both of the time-varying channel constraints and the x-haul capacity constraints, compared to conventional wireless scheduling techniques that may only consider the time-varying channel constraints without respecting x-haul capacity constraints.

Although some example embodiments are described for wireless split processing architectures, the techniques disclosed herein can be similarly extended to split processing in cable or DSL architectures, especially given the similarity in the resource allocation for these technologies. Additionally, although some example embodiments are described in the downstream communication context, the same ideas can be extended to upstream communication as well.

As described above, Passive Optical Network (PON) is a good candidate for implementing the x-haul transport network. However, there is little dependency on the specific x-haul link technology and the same ideas apply even for wireless x-haul technologies.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

We claim:

1. An apparatus for performing integrated scheduling in a cloud-based virtualized radio access network (vRAN) architecture including one or more central units (CUs) and one or more remote units (RUs), the one or more CUs being configured to communicate with the one or more RUs over an x-haul transport network, the apparatus comprising:
a memory storing computer-readable instructions; and
at least one processor associated with the one or more CUs configured to execute the computer-readable instructions to,
determine time-varying channel constraints based on a condition of an access link between the one or more RUs and one or more user equipment (UEs), the access link being in one of a wireless or wireline network,
determine x-haul capacity constraints based on an amount of capacity available on an x-haul link between the one or more CUs and the one or more RUs, the x-haul link being in the x-haul transport network, and
jointly schedule transmissions to the one or more UEs based on the time-varying channel constraints and the x-haul capacity constraints.

2. The apparatus of claim 1, wherein the at least one processor is configured to execute the computer-readable instructions to jointly schedule transmissions to the one or more UEs by determining values which maximize an objective function subject to the time-varying channel constraints and the x-haul capacity constraints.

3. The apparatus of claim 2, wherein the jointly scheduling transmissions to the one or more UEs based on maximizing the objective function includes, for each time step,
scheduling the UE that maximizes a defined criterion for each RU and resource block (RB) pair with respect to the time-varying channel constraints and the x-haul capacity constraints,
tracking an amount of capacity being used and an amount of capacity remaining available on the x-haul link, and
repeating the scheduling and the tracking until the amount of capacity available on the x-haul link is exhausted.

4. The apparatus of claim 1, wherein the jointly scheduling transmissions to the one or more UEs includes avoiding scheduling a UE that would violate the x-haul capacity constraints in response to the amount of capacity available on the x-haul link being unable to handle an amount of traffic associated with the UE.

5. The apparatus of claim 1, wherein the jointly scheduling transmissions to the one or more UEs includes scaling down an allocated rate for a UE in proportion to the condition of the access link of the UE based on the amount of capacity available on the x-haul link such that the x-haul capacity constraints are satisfied.

6. The apparatus of claim 2, wherein the determining the values which maximize the objective function subject to the time-varying channel constraints and the x-haul capacity constraints is performed according to a linear programming (LP) fractional relaxation, wherein an RB can be shared among multiple UEs in a solution to the LP fractional relaxation.

7. The apparatus of claim 6, wherein the at least one processor is further configured to execute the computer-readable instructions to iteratively apply an LP solving algorithm to solve the LP fractional relaxation, and solving the LP fractional relaxation gives the solution to the LP fractional relaxation in terms of fractional variables.

8. The apparatus of claim 7, wherein the iteratively applying the LP solving algorithm to solve the LP fractional relaxation is followed by a rounding procedure of the solution to the LP fractional relaxation, at most one RB per RU can be shared among multiple UEs and all other RBs per RU are allocated to at most one UE, and the at most one RB per RU is allocated to one UE that contributes most to maximizing the objective function out of the multiple UEs, such that the at least one processor is configured to execute the computer-readable instructions to schedule the one UE of the multiple UEs for each RU and RB pair based on the rounding procedure.

9. The apparatus of claim 7, wherein the iteratively applying the LP solving algorithm to solve the LP fractional relaxation is followed by randomized rounding of the solution to the LP fractional relaxation, the randomized rounding treats the solution to the LP fractional relaxation in terms of fractional variables as probabilities, such that the at least one processor is configured to execute the computer-readable instructions to schedule one UE of the multiple UEs for each RU and RB pair based on the randomized rounding according to the probabilities.

10. The apparatus of claim 2, wherein the determining the values which maximize the objective function subject to the time-varying channel constraints and the x-haul capacity constraints is performed according to a dynamic programming (DP) recursion, the DP recursion including,
iteratively calculating optimal solutions for a subset of RBs and a subset of total x-haul capacity, and
building a lookup table for all possible values in order to determine the values which maximize the objective function subject to the time-varying channel constraints and the x-haul capacity constraints.

11. The apparatus of claim 1, wherein the x-haul transport network includes a passive optical network (PON).

12. The apparatus of claim 1, wherein the x-haul transport network is shared between the x-haul link and at least one other communication link, and only a slice of total capacity of the x-haul transport network is reserved for the x-haul link.

13. The apparatus of claim 1, wherein there is a total bound (C) on the amount of capacity available on the x-haul link.

14. The apparatus of claim 1, wherein there are separate bounds (Cᵢ) on the amount of capacity available on the x-haul link for each individual RU of the one or more RUs.

15. The apparatus of claim 1, wherein the access link is associated with a wireless air interface between the one or more RUs and the one or more UEs.

16. A method for performing integrated scheduling in a cloud-based virtualized radio access network (vRAN) architecture including one or more central units (CUs) and one or more remote units (RUs), the one or more CUs being configured to communicate with the one or more RUs over an x-haul transport network, the method comprising:
determining time-varying channel constraints based on a condition of an access link between the one or more RUs and one or more user equipment (UEs), the access link being in one of a wireless or wireline network,
determining x-haul capacity constraints based on an amount of capacity available on an x-haul link between the one or more CUs and the one or more RUs, the x-haul link being in the x-haul transport network, and
jointly scheduling transmissions to the one or more UEs based on the time-varying channel constraints and the x-haul capacity constraints.
